(19) United States
(12) Patent Application Publication
(10) Pub. No.: US 2013/0297519 A1
(43) Pub. Date: Nov. 7, 2013

(54) SYSTEM AND METHOD FOR IDENTIFYING POTENTIAL LEGAL LIABILITY AND PROVIDING EARLY WARNING IN AN ENTERPRISE

(71) Applicants: Nelson Brestoff, Valencia, CA (US); William H. Inmon, Castle Rock, CO (US)

(72) Inventors: Nelson Brestoff, Valencia, CA (US); William H. Inmon, Castle Rock, CO (US)

(21) Appl. No.: 13/931,644

(22) Filed: Jun. 28, 2013

Related U.S. Application Data
(63) Continuation-in-part of application No. 12/103,144, filed on Apr. 15, 2008.
(60) Provisional application No. 61/672,247, filed on Jul. 16, 2012.

(51) Int. Cl. G06Q 50/18

(52) U.S. Cl. CPC G06Q 50/18; G06Q 10/107
USPC 705/311

(57) ABSTRACT

A system for detection of potential legal liability is presented. The system uses factual information that has triggered liability based on any number of legal theories, and compares the words expressing those facts to customer and employee communications in order to identify potential liability to an enterprise by reviewing of the enterprise's emails. The system generates seeding information based on the factual information and words expressing certain sentiments, and provides the seeding information to a document fracturing engine which scans the email archives and identifies emails with words that potentially give rise to a liability risk. The identified emails may then be reviewed by authorized personnel so that appropriate proactive and/or corrective action may be taken before the legal liability occurs.

### CROSS-REFERENCE TO RELATED APPLICATIONS

The present application claims the benefit of U.S. Provisional Application Ser. No. 61/672,247, filed on Jul. 16, 2012, and is a Continuation-in-Part of U.S. patent application Ser. No. 12/103,144, filed on Apr. 15, 2008, all of which are herein incorporated by reference for completeness of disclosure.

### BACKGROUND OF THE INVENTION

1. Field of the Invention

Embodiments of the invention described herein pertain to the field of preventative law. More particularly, but not by way of limitation, one or more embodiments of the invention enable discovery of potential legal liabilities in electronic communications within an enterprise thereby enabling proactive action to prevent costly litigation.

2. Description of the Related Art

Law professor Louis M. Brown (1909-1996) advocated “preventive law.” Indeed, he arguably pioneered the concept. His philosophy was this: “The time to see an attorney is when you're legally healthy—certainly before the advent of litigation, and prior to the time legal trouble occurs.” He likened his approach to preventive medicine. For example, when he was president of the Beverly Hills, California Bar Association, he launched a program to give free legal advice to young couples before they were married. For one of his clients, having noticed that their freight trucks were getting into costly accidents when making left hand turns, he recommended a policy that drivers instead make three rights. Over time, this approach to law has faded. There are no journals and no annual conferences.

Nevertheless, in modern society, entities such as commercial businesses, not-for-profit, governmental organizations, and other ongoing concerns (“enterprises”) are exposed to potential liabilities if they breach contractual, criminal, governmental, or tort obligations. They face a myriad of statutes and regulations, comprising, for example, the Securities and Exchange Act, the Foreign Corrupt Practices Act, export laws, rules preventing businesses from having dealings with current and former government employees and/or officials, food and product safety regulations, the Sarbanes-Oxley Act, labor laws, and a list too long for a point now already made.

Many, if not most enterprises, also realize that compliance programs function best when they are grounded in an enterprise's core values for ethical conduct. These core values must be driven by the individuals who are in control of the enterprise. They must set standards of conduct for all employees and independent contractors. Ultimately, they do so for the benefit of their customers and stakeholders.

Today, the law and these standards of conduct require enterprises to be strict stewards of the electronic data they generate internally and the data (e.g., personal identifying information, medical information) they accumulate from third parties. Indeed, in order to safeguard the privacy of others, enterprises are likely to adopt strict policies that curtail if not eliminate the privacy of their own employees when they use the enterprise's computers.

It is common knowledge that employee misbehavior has, on occasion, severely impaired an enterprise, if not harmed an entire marketplace. Such misconduct can lead to enormous monetary losses through lawsuits and/or civil penalties. Sometimes, severe misconduct escalates to the level where criminal charges are filed. In the early 1990s, the federal Sentencing Guidelines provided benchmarks for misconduct. The Sentencing Guidelines make room for mitigating conduct and actions that speak against the heaviest penalties. In this context, preventive law may function to avoid criminal prosecution altogether because, by using the system of the present invention to find and prevent harm, the specific intent to do harm is negated.

Moreover, as a supplement but not a substitute for obtaining timely legal advice, enterprises have published ethical guidelines and/or compliance standards and made them widely available using computer-based resources. However, such publications are, by themselves, insufficient, in part because people often eventually forget what they read.

Without a computer-based system of detecting—and then addressing—the textual or graphical data that could lead to potential contractual or tort liabilities and/or criminal penalties, the ethical policies, trainings, and publications are more inspirational and aspirational than useful. It is the purpose of this invention, therefore, to provide a system and method for what may be called electronic preventive law. The need for electronic preventive law, as described herein, is great. In 2010, the cost of commercial torts (that is, tort costs alleged against businesses including all medical malpractice tort costs, but excluding the personal tort costs stemming predominantly from automobile accidents) was, according to Towers Watson, $168 billion. The goal of electronic preventive law is to detect misconduct before it results in harm; that is, damage to the enterprise or to third parties, and so permit the enterprise to avoid the associated costs, including but not limited to e-discovery costs, attorney's fees, settlements, and judgment debtor obligations, not to mention losses in employee productivity when their attentions are diverted by having to deal with litigation. Even if the enterprise were able to identify only a small fraction of the potential legal liabilities it may face, and do so in time to avoid the multiplicity of adverse consequences, the savings would be significant. There is great value in less litigation.

Thus, there is a need for a system capable of identifying potential legal liability and providing early warning to appropriate personnel.

### BRIEF SUMMARY OF THE INVENTION

One or more embodiments of the invention are directed to a computer-based system for identifying potential legal risks. The system utilizes a specially programmed computer to obtain factual information associated with a host of the liabilities an enterprise may face. By accessing and storing facts from various sources, such as case law, legal treatises, and complaints, the system generates a taxonomy of trigger words which, when augmented with synonyms, pertain to particular areas of the law, e.g., employment law. Each such area of law may be comprised of sub-topics, e.g., age discrimination, racial discrimination, gender discrimination, etc. For each such area or sub-topic, the taxonomy of “trigger words” will be emblematic of the topic itself. For example, source materials using the word “old” may signify a potential age discrimination threat, while source materials containing the pejorative use of “bitch” indicate a potential gender discrimination threat. Each taxonomy of “trigger words” for a specific legal category (e.g., age or gender discrimination), which collectively is referred to as “Seeding Information,” will be augmented by a taxonomy of “words of worry,” such as “nervous,” “risky,” and “jail.” Together, the “Seeding Information” and “Words of Worry” are collectively referred to as “Words of Concern.” The Words of Concern become a set of parameters for use by a detection engine. Words of Concern based on an enterprise's set of previous litigation matters, and the litigation matters experienced by enterprises in the same or very similar field of endeavor (as indicated when different enterprises have the same SIC code), may be said to form a litigation risk profile specific to the enterprise. Some sets of Words of Concern apply to every enterprise, e.g., the employment discrimination sub-topics. Thus, the Words of Concern parameters may be specific or general. Once the parameters are available, e.g., in an on-site server or cloud-based environment, the system is set up to receive the data environment of the enterprise, particularly emails and attached documents, since such data may match up with one or more of the “Words of Concern” taxonomies. If so, they might constitute liability risks. If facts that potentially give rise to a liability risk are identified during the scan, the system then looks for such words to see if they occur (a) frequently within a given number of other words or within an email or document (“Frequency Words”) and (b) within a certain proximity to other words; weights those words in accordance with user instructions, and then ranks the Words of Concern to discern the high-ranking risks of potential legal liability. Of course, to reduce the prospect of too many false positives, the system is tunable such that a user may set the level of the highest-ranking documents that will be output to the various users. These high-ranking emails and/or documents are then made available to the user who is authorized to review the documents, to investigate further, and to report to other authorized users for further investigation or internal, proactive handling; and to thereafter use the results to further train the system.

The methodology set forth herein is able to make use of multiple sources of factual information to create the subject matter “trigger words.” For example, the factual information the system utilizes may include factual allegations in complaints from litigation records associated with the enterprise, or with other enterprises having a same or similar SIC code. (Still other codes identifying an industry type are also within the scope and spirit of the invention.) The factual information may include but is not limited to a compilation of factual allegations previously presented as pre-litigation demands, a compilation of factual allegations previously presented as part of court orders or opinions issued in a filed lawsuit; factual details extracted from hypothetical examples of potential legal liability as posed and input by authorized personnel; factual details extracted from learned treatises as identified by authorized personnel; factual details from employee complaints; and factual details from customer complaints; and so on.

Users of the system are those individuals who are authorized by the enterprise utilizing the system to do so. In order to preserve the attorney-client privilege, such authorized personnel must be attorneys or non-attorneys acting under the direction or control of attorneys who are employed by the enterprise. It is the authorized personnel who review the system's output, use the system to investigate and identify other employees who may be involved in a potential liability risk, and who provide hypothetical or further training input to the system's detection engine of taxonomy parameters. In addition, it is the authorized users who may set ranking levels for the reporting of potential legal liabilities. They determine the threshold of what information gets reviewed, because they are best situated to avoid having the system over report or under report.

Once the system scans and detects potential liabilities that it identifies as high-ranking risks, and the authorized personnel have used the system or other means to conduct whatever further investigation they may desire, then, in order to preserve the attorney-client privilege, reports of any identified risk for further action must be made to other attorneys for the enterprise or non-attorney executives employed by the enterprise and who are members of the enterprise's control group. However, when potential liabilities are identified, they are noted as such by the system, and may be augmented by authorized users, and subsequent scans conducted by the system take into account what the system has learned from previously identified potential liabilities. In this way, the system is able to learn from its prior experience as it continues forward with the process of seeking to identify potential liabilities.

### BRIEF DESCRIPTION OF THE DRAWINGS

The above and other aspects, features and advantages of the invention will be more apparent from the following more particular description thereof, presented in conjunction with the following drawings:

FIG. 1 illustrates an example of a pre-processing logic, according to an embodiment of the invention, for pre-processing unstructured text to improve the text's use as a data source for an analytical data processing tool;

FIG. 2 illustrates three example snippets of text expressing dates in three different formats, along with an alternative representation of each date specified in a standardized format, in accordance with an embodiment of the invention; from various sources of unstructured text;

FIGS. 3 and 4 illustrate examples of an index with words from an unstructured text before and after pre-processing logic has added alternative representations of certain words that are included in a taxonomy of words, according to an embodiment of the invention;

FIG. 5 illustrates an example of an index including words from an unstructured text before and after pre-processing logic has added an alternative word to represent the existence of two specific words within close proximity to one another, according to an embodiment of the invention; and

FIG. 6 illustrates an example of an index including words from an unstructured text before and after pre-processing logic has added a variable to represent the existence of two specific words within close proximity to one another, according to an embodiment of the invention.

FIG. 7 is a block diagram of an example computer system and network 100 for implementing embodiments of the present invention.

FIG. 8 illustrates an example process of identifying potential liability in accordance with one or more embodiments of the present invention.

FIG. 9 illustrates an example Relevance Taxonomy for a Business in accordance with one or more embodiments of the present invention.

FIGS. 10A-B illustrate the process of generating analysis parameters in accordance with one or more embodiments of the invention.

FIG. 11 illustrates an example of Words of Concern in accordance with one or more embodiments of the present invention.

FIG. 12 illustrates an example of Proximity Words in accordance with one or more embodiments of the present invention.

FIG. 13 illustrates an example of Frequency Words in accordance with one or more embodiments of the present invention.

FIG. 14 is a graphical illustration of the process in accordance with one or more embodiments of the present invention.

### DETAILED DESCRIPTION

A computer based system and method for determining potential legal liability and providing early warning will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements (e.g., precision and recall metrics) well known to those of ordinary skill in the art have not been described in detail, so as not to obscure the invention. Furthermore, as previously indicated, taxonomies should be understood to be an ever-evolving cluster of words to describe a legal subject (such as age discrimination) or express a sentiment, including each of the synonyms for each such word. Readers should note that although examples of the invention are set forth herein, the claims, and the full scope of any equivalents, are what define the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The terms “first,” “second,” and the like, herein do not denote any order, quantity or importance, but rather are used to distinguish one element from another, and the terms “a” and “an” herein do not denote a limitation of quantity, but rather denote the presence of at least one of the referenced item.

Existing search technologies are typically used in the standard model for the discovery of electronic information, known as the Electronic Discovery Reference Model (the “EDRM”). The EDRM describes processes that take place after litigation can be reasonably anticipated. The purpose of such searches is to find and preserve potentially relevant documents that may be requested during the discovery process, and which may have to be produced if not subject to being withheld as privileged. There is no aspect of the EDRM, including the Information Governance Reference Model (the “IGRM”), where search technologies are part of an effort to identify documents indicative of potential legal liabilities in order to prevent or minimize harm and the associated costs.

The EDRM has existed since May 2005. It is expressly a conceptual, non-linear, iterative model. In the EDRM, the IGRM (added circa 2009) is on the far left of the e-discovery workflow model, while Presentation (at trial) is on the far right. In between, the generalized processes include identification, preservation, collection, processing, review, analysis, and production. These in-between processes are, generally speaking, the usual focus of e-discovery efforts.

Currently, various search technologies are used during the Review and Analysis steps of the EDRM to, among other things, avoid producing irrelevant or confidential documents, or documents covered by the attorney-client privilege or the work product doctrine. More recently, under the heading “Early Case Assessment,” producing parties use search technologies, e.g., based on key words and Boolean connectors or latent semantic indexing and variations thereof, and process technologies dubbed “predictive coding,” computer-aided review (“CAR”), or technology-aided review (“TAR”) to inform themselves about the documents that may be responsive, and must be produced, or which should not be produced during litigation. These approaches may also be used to discern the strengths or weaknesses of litigation that is either already reasonably foreseeable or is under way.

Production is the last step for a party producing electronically stored information (“ESI”) to a requesting party. Requesting parties must then search the documents they requested for information that will help them prove a claim or a defense. That task can be daunting. Should a producing party produce its documents on a single flash drive, that drive might contain many gigabytes (and in some cases, terabytes) of data. Should a requesting party be required to print out that data, in order to conduct a manual (“linear”) review, only ten (10) gigabytes could translate into as much as 750,000 pages of printed information.

The costs of reviewing potentially relevant information can be enormous. According to one observer, the cost of e-discovery for a large company is more than a million dollars for each and every lawsuit. In one recent case, to comply with a third party subpoena, the Office of Federal Housing Enterprise Oversight had to produce 80% of all of its email, which required it to hire 50 contract attorneys and spend $6 million, which amounted to nine percent of its entire annual budget. See In re Fannie Mae Secs., 552 F.3d 814, 818 (D.C. Cir. 2009).

The present invention describes a system that helps an enterprise avoid the problem of having to search for potentially relevant documents in the context of litigation by using search methodologies to identify misbehavior even before litigation becomes reasonably foreseeable, because there can be no litigation without damages. In other words, the system's objective is to identify potential liability before any damage has been caused. The goal is to avoid litigation altogether or, at least, greatly mitigate the costs associated with it.

The following document is incorporated by reference in its entirety, as if fully set forth herein: “Data Lawyers and Preventive Law” by Nick Brestoff, published Oct. 25, 2012, and archived at http://www.intraspexion.com/.

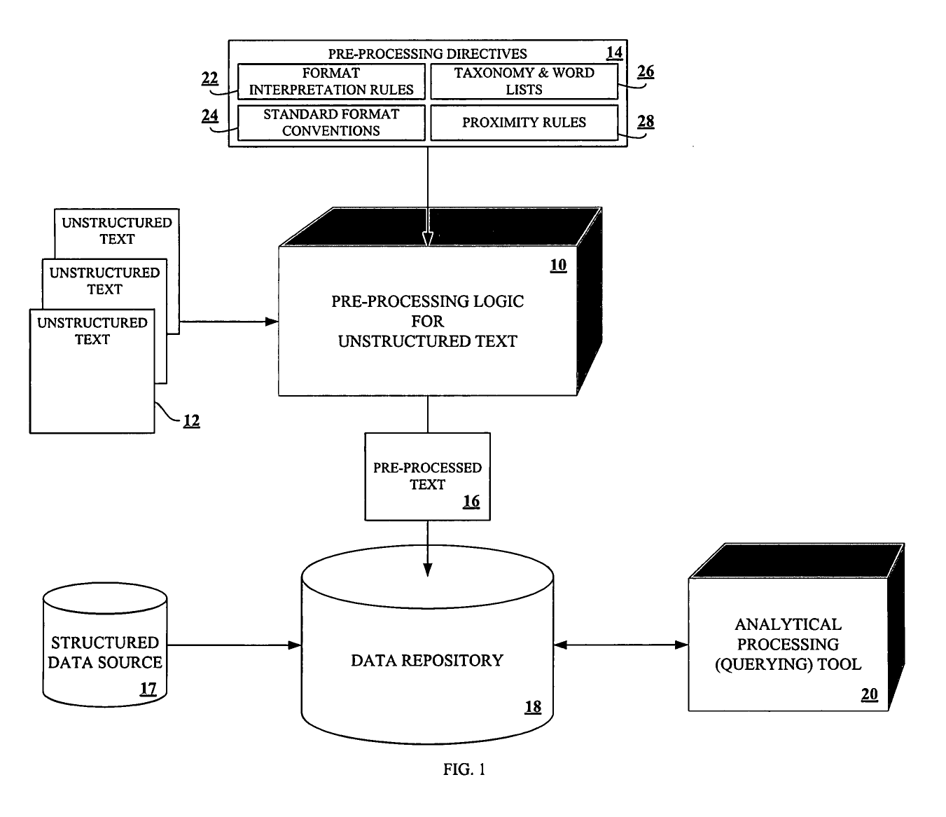

One or more embodiments of the present invention will now be described with references to FIGS. 1-14.

Identifying Potential Legal Liability

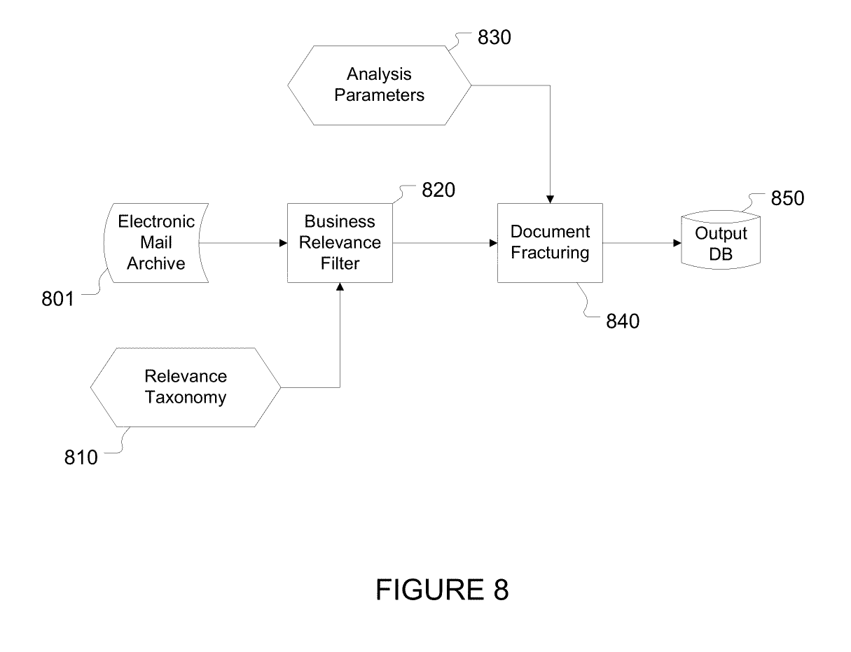

FIG. 8 is an illustration of the process of identifying potential liabilities in the electronic communication of an enterprise in accordance with one or more embodiments of the present invention. The process begins with identification of emails, including their attachments that relate to the business purpose of the enterprise. This is accomplished by what is described to herein as the Relevance Screening Process. The Relevance Screening Process essentially removes (or isolates) spam and blather from the archive of electronic mails to be analyzed for potential chatter that could lead to legal liability. This step would be necessary in enterprises in which the archive of electronic mails includes discussions that are not relevant to the business purpose, e.g. jokes, sports after work hours (e.g. bowling and golf), personal discussions, etc. The Relevance Screening Process would eliminate these emails from the pile, thus reducing the data to only business relevant electronic mails. As illustrated in FIG. 8, the first step in the Relevance Screening Process is to define the Relevance Taxonomy for the enterprise in block 810.

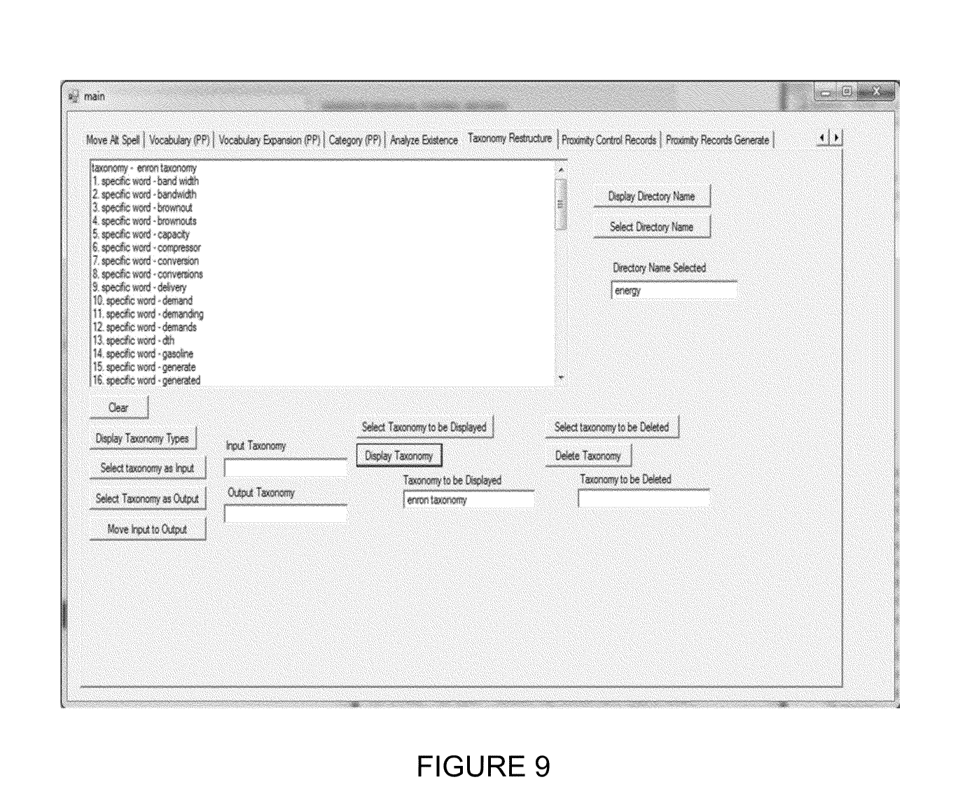

In general, the Relevance Taxonomy for an enterprise depends on the type of business the enterprise is engaged in. For instance, a business engaged in the oil and gas related fields, the Relevance Taxonomy could be generated from the “Energy” and “General Business” taxonomies. A business engaged in medical devices could have the Relevance Taxonomy generated from “Healthcare” and “General Business” taxonomies, and so on. After the business related taxonomies are defined, a list of specific words relating to those taxonomies is generated to form the Relevance Taxonomy, as illustrated in FIG. 9. Sample words in the Relevance Taxonomy in the current illustration (for an Energy related enterprise) are Bandwidth, Brownout, Capacity, Gasoline, Generate, etc.

After the Relevance Taxonomy is created, the archive of electronic mails is run through Filter 820 to reduce the data to only business relevant electronic mails. In one or more embodiments, the filter is an integral part of the Textual ETL engine discussed herein. For example, the filter may be a pre-processor in the Textual ETL engine or the Textual ETL engine itself The filtering process 820 analyzes the entire archive of electronic mails 801, including text and attachments, and discards electronic mails that do not contain one or more words from the list of specific words in Relevance Taxonomy, thus retaining only business relevant electronic mails for further analysis by the Document Fracturing process 840. It should be noted that the filtering is not limited to stored electronic mail. Those of skill in the art would appreciate that real-time processing of electronic mail traffic within an enterprise system may be implemented with the system and methods described herein. Thus, one or more embodiments of the present invention contemplate processing of real-time electronic mail traffic.

The next step after the filtering process is the document fracturing process. This process, also known as textual disambiguation or Textual ETL, breaks down each electronic document to search for analysis parameters 830. Analysis parameters are essentially those words or combinations of words that when contained in an electronic mail may indicate discussions about conduct that could lead to some form of legal liability. For instance, the word “attorney” in an email may indicate discussion of privileged information, while the word “bet” may indicate improper risk taking. Thus, the analysis parameters consist of word clusters needed to screen each electronic mail by the textual ETL engine.

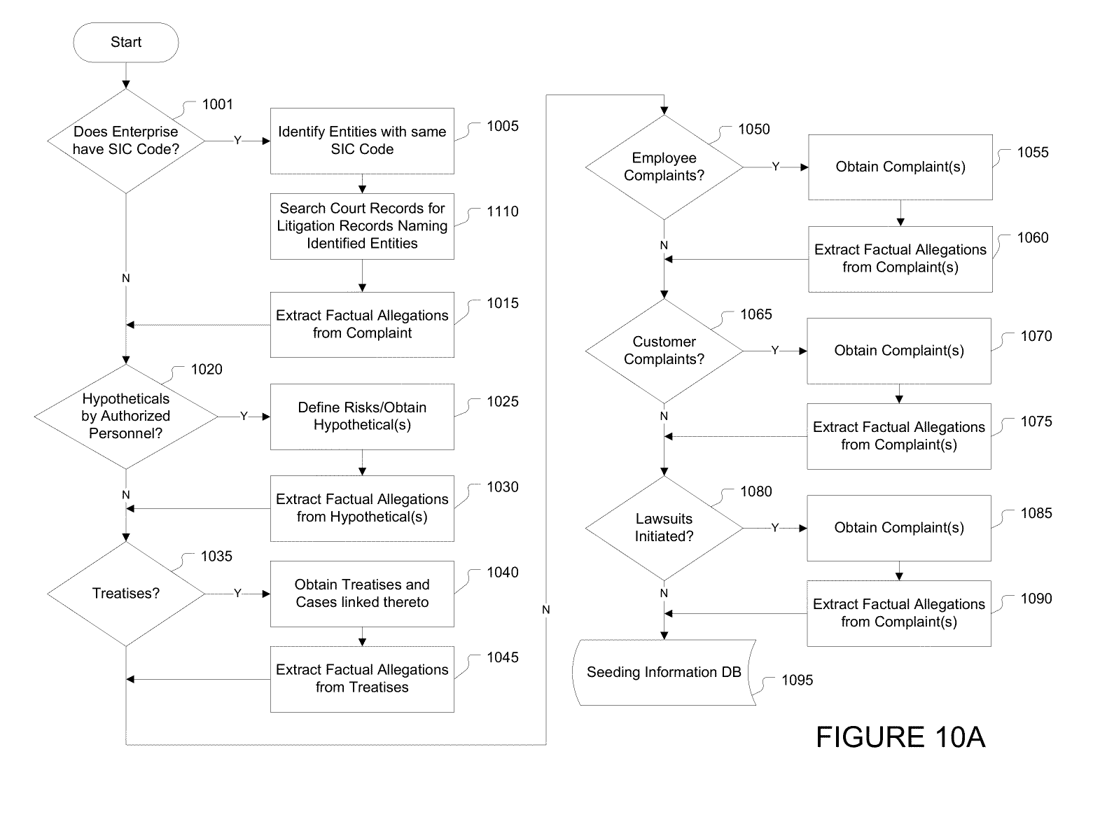

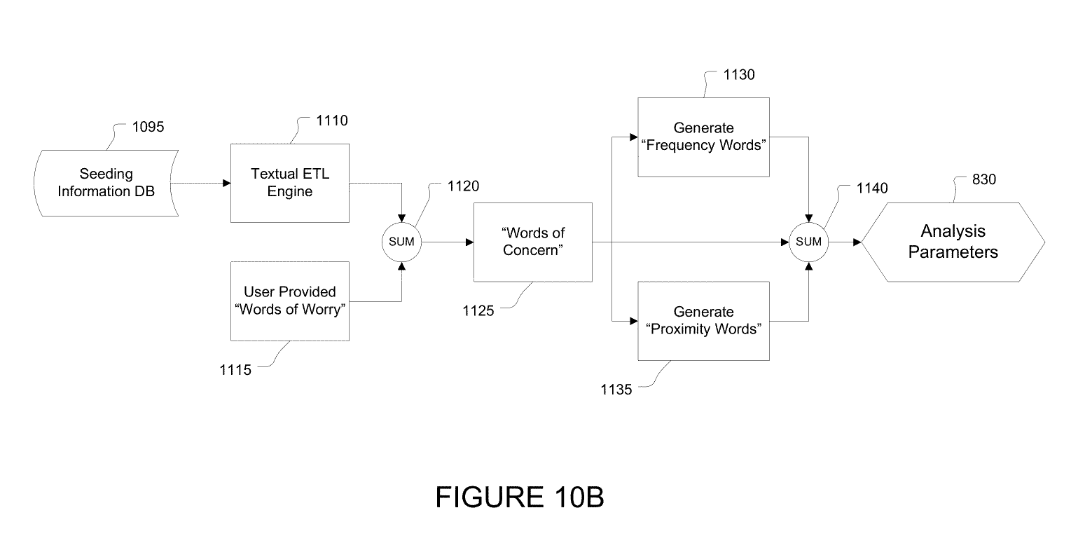

The analysis parameters are defined in FIGS. 10A and 10B in accordance with one or more embodiments of the present invention. These analysis parameters include one or more of what are referred to herein as subject matter Trigger Words, also referred to as Seeding Information, and “Words of Worry,” which together constitute “Words of Concern” for specific topics, and “Proximity Words” and “Frequency Words.” Those of skill in the art would appreciate that other analysis parameters may be added and that these parameters may be referred to by different labels. Thus, the labels used herein are for illustrative purposes only, and are in no way intended to limit the scope of the invention.

FIGS. 10A-B illustrate the process of generating analysis parameters in accordance with one or more embodiments of the invention. The process starts with the assembly of Trigger Words from a variety of sources, the result of which is the Seeding Information in database 1095 as illustrated in FIG. 10A. Seeding Information comprises risk related factual information identified or obtained for the enterprise to be evaluated by the system in accordance with one or more embodiments of the present invention. Seeding information may be siloed by subject matter, e.g., specific types of legal liabilities that may confront an enterprise, a combination of such subject matters, or grouped as generalized types or sets of legal liabilities.

The sequence of steps for generating seeding information database 1095 illustrated in FIG. 10A is generally inconsequential so long as in the end enough information is obtained to create the seeding information for the enterprise. In the embodiment illustrated in FIG. 10A, a determination may be made whether the enterprise being evaluated has an SIC or industry code. The purpose of obtaining the SIC code is to provide a basis for a risk comparison against similarly situated entities to the one under evaluation. Entities with the same SIC or industry code are identified in step 1005 so that a search of one or more databases of court records for litigation records naming the identified entities is performed in step 1110. This enables the system to identify the types of litigation that have been initiated against entities of a similar nature and therefore determine probabilities associated with similar lawsuits being initiated against the entity being evaluated. If, for example, a certain type of litigation is commonly initiated against similarly situated entities as the entity being evaluated, the risk profile for such litigation is increased and the Seeding Information may be weighted to look for such information. This is achieved in one or more embodiments of the invention by obtaining the complaints from the lawsuits filed against similarly situated entities, e.g. with the same or similar SIC codes, and extracting the factual allegations from one or more databases of complaints at step 1015. The factual allegations may be obtained, for instance, from sections in the complaint document identified as “Background,” “Background Facts,” “Facts,” “Factual Background,” etc. Published and unpublished opinions by appellate courts at all levels are yet another likely source. The goal is to preferably extract sections in each complaint document that factually describes the basis for the allegation supporting a claim or cause of action of legal liability.

In building the Seeding Information, another optional step is to determine if there are hypotheticals to be evaluated by authorized personnel at step 1020. If so, the system is configured to obtain the hypotheticals from authorized personnel 1025. These hypotheticals include information the authorized personnel may identify as being relevant, e.g., if the enterprise is subject to one or more newly enacted statutes or regulations, and may for example be written as fact patterns that potentially give rise to liability. In essence the system provides a method for authorized users to identify and describe potential risks by posing a hypothetical set of facts. Factual information is then extracted from the one or more databases of hypothetical(s) at step 1030 for use in building the Seeding Information.

If treatises are available and any of the articles, and the cases cited therein, are deemed applicable to the subject matter of interest 1035, the treatises may be a source of case law facts at step 1040, and extracts of the passages likely to contain trigger words from the treatises at step 1045 may be used to further build up the database of Seeding Information 1095.

Another source of information useful for obtaining information about the risks associated with a particular enterprise is human resource records. Thus the system may be configured in one or more embodiments of the invention to evaluate whether there are any records of employee complaints at step 1050. For example, if records about instances of age discrimination, gender discrimination or any other complaints were initiated by employees of the enterprise, those employee complaint records are obtained from the one or more databases of employee complaints in block 1055 and provided to the system, where factual allegations are extracted from the records at 1060.

The system may also check if customer complaints exist in step 1065, and if they exist, these complaints are also obtained from the one or more databases of customer complaints at step 1070 so that factual allegations may be extracted from the customer complaint(s) at step 1075. For example, customer complaints about product quality and or dangerous aspects of the product are a valuable source of facts indicating a potential for harm. Product liability claims are costly to defend and using the system implementing one or more embodiments of the present invention the risk of such claims may be identified prior to any lawsuit being initiated, resulting in a massive reduction of cost if appropriate and corrective actions are taken based on the threats flagged by the system and follow-up investigations.

Another rich source of information that is useful for assessing risk consists of the lawsuits previously filed against the enterprise. Thus, in one or more embodiments of the invention, the system may check if lawsuits have been initiated against the entity being evaluated in step 1080. And if so, the complaint and/or other relevant and factually rich pleadings are obtained from the one or more legal databases in step 1085. The factual allegations that resulted in the litigation are then extracted from the complaint and relevant pleadings in step 1090 and made part of the Seeding Information database.

Once the system obtains the factual information from at least one of the various sources described above, this factual information is utilized to construct Seeding Information database 1095. As illustrated in FIG. 10B, Seeding Information 1095 feeds into the Textual ETL engine 1110, which is described further in this specification.

A pre-processor in the Textual ETL engine 1110 generates as output what has been referred to herein as “Trigger Words,” which is essentially a taxonomy of subject matter words that may trigger legal liability for the enterprise. The “Trigger Words” comprises the output of the pre-processor in Textual ETL engine 1110 processing the Seeding Information database 1095, based on, for example, a list of parameters which may include words to exclude, and or any other set of words/parameters provided by the system or the user to include. The Trigger Words are saved in silos (i.e., folders) and identified by topic of law.

Over time the subject matter silos keep filling up, thereby creating a library of Trigger Words for different areas of legal liability. Thus, the system maintains Trigger Words for problem area A, problem area B, problem area C, etc. The system is constantly adding to the silos based on system and user input. Thus, a client may generate Trigger Words from scratch or use what is already available in the library of Trigger Words for the problem area of interest.

The Trigger Words from block 1110 are summed with any additional risk related words identified or provided by authorized personnel. Trigger Words are then added to the sentiment words, identified herein as “Words of Worry” 1115, in summer block 1120, to generate “Words of Concern” 1125.

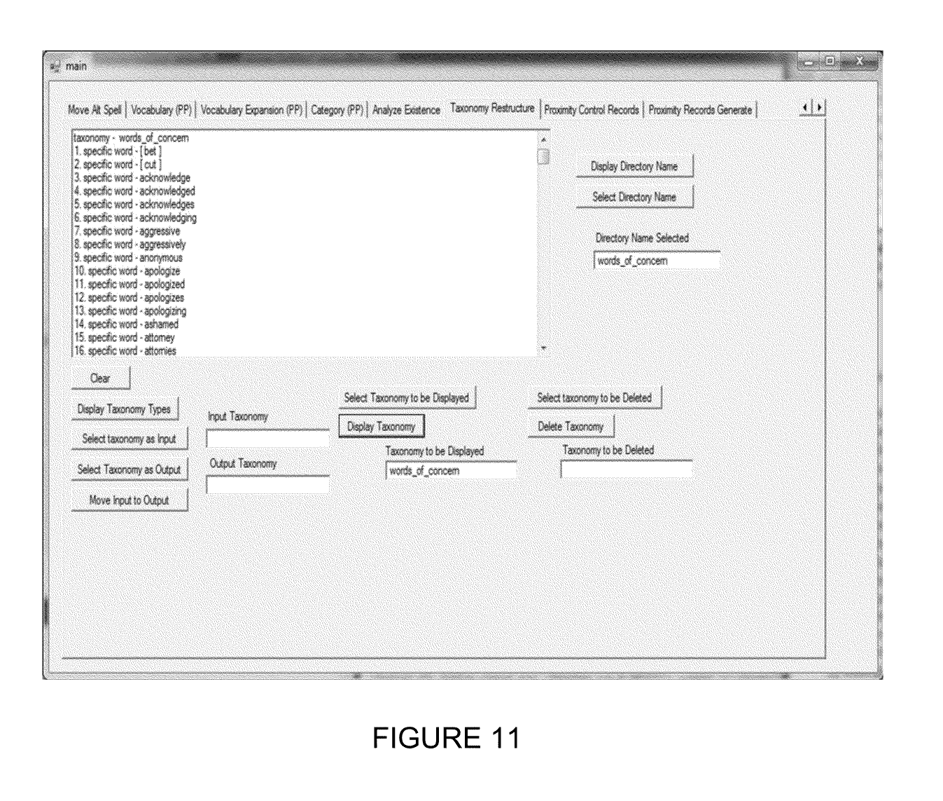

“Words of Concern” 1125 are those words which if included in an electronic mail would give the user cause to review the communication for potential inappropriate business conduct or disclosure of activities that could potentially lead to legal liability for the enterprise. For instance, words such as aggressive, anonymous, apologize, ashamed, attorney, etc. in an email may require that the email be further reviewed for inappropriate conduct because such words may connote some form of wrongdoing, or in case of “attorney,” a discussion of privileged information. A sample list of Words of Concern is illustrated in FIG. 11. The list in FIG. 11 is not exhaustive and would generally depend on the type of enterprise being analyzed and may also vary according to the type of potential liability that the enterprise is trying to avoid. Thus, it is contemplated that some or all of the Words of Concern may be provided by the user of the systems of the current invention. One or more embodiments of the system of the present invention may also include built-in “Words of Concern” relating generally to known types of legal liabilities.

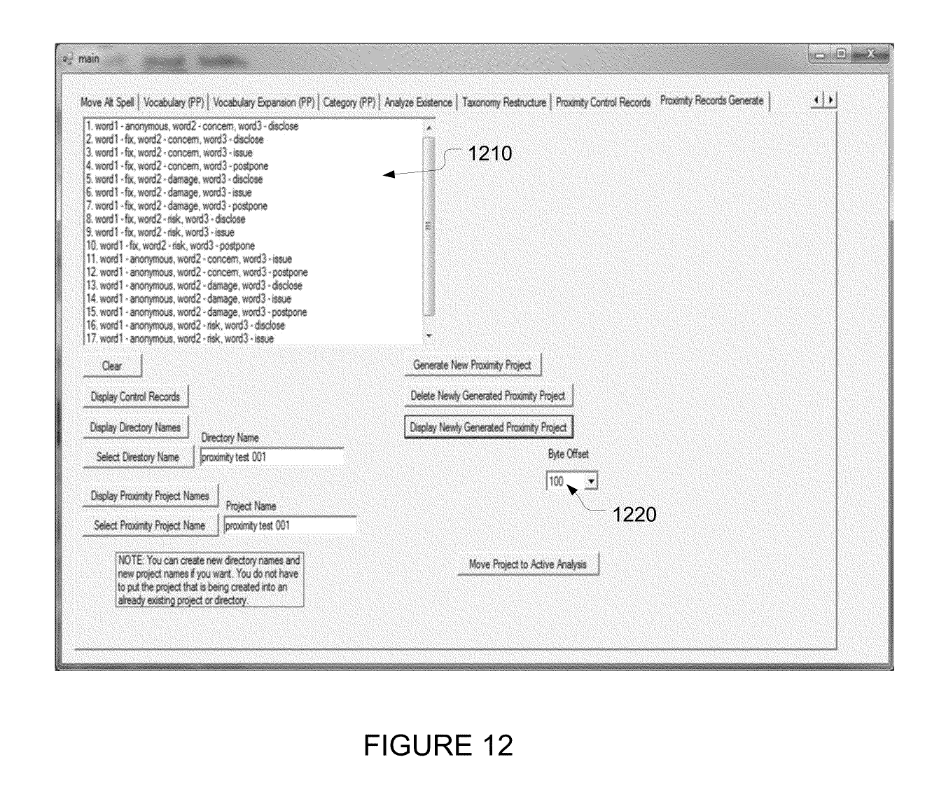

“Proximity Words” 1135 are generated from a combination of a plurality of words from the list of “Words of Concern” and are generally words that, when they occur in close proximity, may indicate a higher potential for liability, and so be assigned a greater weight for ranking purposes. FIG. 12 is an illustration of sample setup for proximity words in accordance with one or more embodiments of the present invention. As illustrated, in block 1210 is a list of words that would be analyzed in proximity to each other in the example enterprise being analyzed. For instance, if the words: “anonymous,” “concern,” and “disclose” are within 100 bytes (see “Byte Offset” block 1220) of each other in an electronic mail, the electronic mail will be highlighted. Similarly, if the combination of the words “fix,” “wagon,” and “jail” are within 100 bytes of each other, the electronic mail will be highlighted. Thus, in one or more embodiments of the present invention, the system generates combination of words for the proximity analysis; in addition the user may specify as many proximity words as desired. The Byte Offset 1220 is used to control the boundaries for proximity analysis and it is user controlled. In one or more embodiments, the user may set the Byte Offset to any desired value.

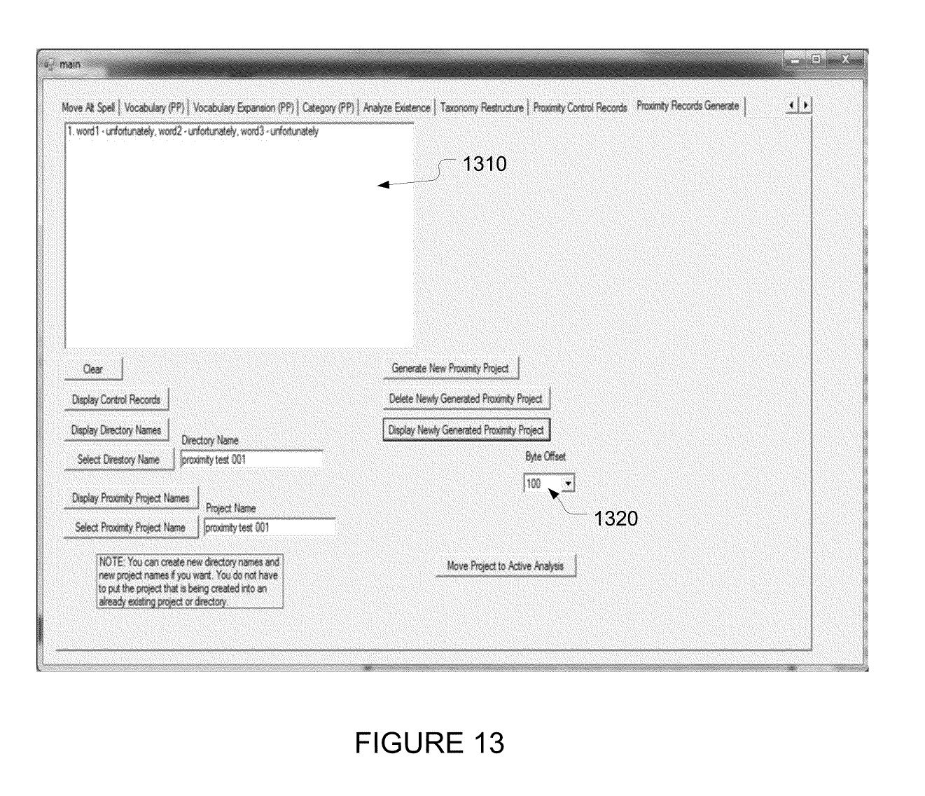

Returning to FIG. 10B, another category of analysis parameters is “Frequency Words” 1130. These are generated from the list of “Words of Concern” and also signal a greater potential for legal liability. Frequency Words are words (and variations of those words) from the list of “Words of Concern” which occur more than once in close proximity. For instance, as illustrated in FIG. 13, the word “unfortunately” may be used as a Frequency Word. In this illustration, the Frequency Word is setup such that if the word “unfortunately” occurs three times (i.e. 1310) within 100 bytes (i.e. Byte Offset 1320) of data in an electronic mail, the electronic mail is highlighted for further review (i.e. for output). The user may add as many Frequency Words as desired.

After generation of the “Frequency Words” and the “Proximity Words,” they are summed with the “Words of Concern” in summer block 1140 to generate the “Analysis Parameters.” It should be noted that other variables may also be included in the Analysis Parameters for the Document Fracturing engine 840 (FIG. 8). In one or more embodiments of the present invention, the same user interface used for configuring “Proximity Words” may also be used for configuring “Frequency Words.”

Returning back to FIG. 8, after the analysis parameters 830 are defined, Document Fracturing process 840 (also referred to herein as Textual ETL) processes the Business Relevant emails generated in the Filter process 820 using Analysis Parameters 830 to generate the final Output in repository 850. The data in Output repository 850 are only those emails that meet the criteria that were analyzed using the Analysis Parameters. Data in Output 850 may subsequently be analyzed by authorize personnel to identify other employees involved in the actionable or problematic communication, and to take appropriate investigatory or reporting actions.

In some instances, data in Output 850 may still comprise a large number of emails, thus analytical tools that allow the user to sort the data into manageable groupings may be employed. For instance, it may be desirable to only review data within a certain date range, by subject, by sender, by recipient, etc. Also, it may be desirable to review emails by the number of Words of Concern found therein. For instance, a user may want to start with the email containing the most number of Words of Concern. The analytical tool is preferably capable of displaying to the user locations, in each email, of any Words of Concern used to highlight that email for output. Various visualization tools are also contemplated to indicate relationships between senders and receivers of electronic mail, whether they are employed by the enterprise or are outside it, and how the frequency of communications change over time.

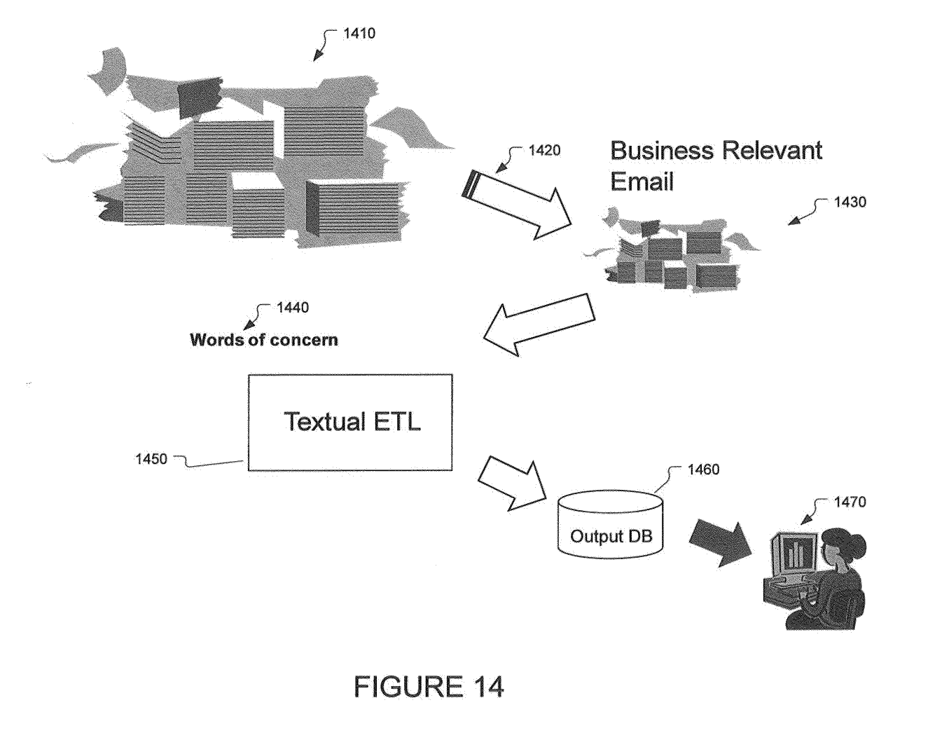

FIG. 14 is a graphical illustration of the process in accordance with one or more embodiments of the present invention. As illustrated, the archive of electronic mails in block 1410 is significantly reduced to Business Relevant Email 1430 by the filter process 1420. The Business Relevant email 1430 and Words of Concern 1440 are then fed as input to Textual ETL engine 1450 to generate output database 1460. Output database 1460 is accessible by any authorized user via a client computer 1470 for review and identification of issues and communications that may potentially lead to legal liability, and so enable a user and/or control group executives to take further investigatory, preventive and/or corrective action. Those of skill in the art would appreciate that Client computer 1470 could be any type of device with a user interface that provides an ability to review data in output database 1460, e.g. desktop, laptop, smart phones, tablets, etc.

Textual ETL Engine

In one aspect, the present invention involves analyzing an unstructured text to identify textual elements of a particular type that are expressed in formats inconsistent with predefined standard formats for each type of textual element. As used herein, the term “textual element” refers to a word, phrase or number within the unstructured text. For example, a date written as “Dec. 15, 2007” is a textual element of the “date” type. Although there may be a wide variety of textual element types in any particular embodiment of the invention, the examples provided herein include dates, times, written numbers, and a special type referred to herein as a “taxonomy word” type. Those skilled in the art will appreciate that the invention is independent of any particular nomenclature used to specify the various textual element types, variable names, and so forth.

FIG. 1 illustrates an example of pre-processing logic 10, according to an embodiment of the invention, for pre-processing unstructured text to improve the text's use as a data source for analytical data processing tools. Although the pre-processing 10 logic might be implemented in part, or entirely, in hardware, generally the pre-processing logic 10 is implemented as part of a software application. As such, the pre-processing logic 10 may be implemented to operate on a wide variety of computer systems, and the present invention is independent of any particular hardware or software platform. Furthermore, the processing directives and operations described herein are sometimes referred to as pre-processing directives and operations in view of the additional processing that occurs after the unstructured text(s) have been conditioned for use as a data source for one or more analytical processing tools 20.

As illustrated in FIG. 1, the pre-processing logic 10 takes as input one or more unstructured texts 12 such as electronic mails and a set of pre-processing directives 14, processes the unstructured text(s) 12 in accordance with the pre-processing directives 14, and then outputs pre-processed text 16 to a data repository 18. The exact format of the pre-processed text 16 output by the pre-processing logic 10 may vary depending upon the particular implementation and the data repository 18 being utilized. Furthermore, the pre-processed text 16 may be combined or associated with one or more other data sources, to include a structured data source 17. For instance, if the data repository 18 is a database, the pre-processed text 16 may be output in a form that allows it to easily be inserted into one or more database tables along with data from an additional structured data source 17. The data repository 18 may be an index, a database, a data warehouse, or any other data container suitable for storing the pre-processed text 16 in a manner suitable for analysis by analytical processing tools 20. The pre-processing directives 14 used in processing the unstructured text(s) 12 include format interpretation rules 22, standard format conventions 24, taxonomy and word lists 26 and proximity rules 28.

The first set of pre-processing directives—the format interpretation rules 22—is user-configurable and instructs the pre-processing logic 10 on how to interpret various textual elements found in an unstructured text. A different format interpretation rule 22 may be defined for each textual element type to indicate how that particular textual element type (e.g., dates, times, numbers) is to be interpreted by the pre-processing logic 10. Furthermore, a default format interpretation rule may be specified for those instances when a user-specified format interpretation rule cannot be used to accurately infer the meaning of a textual element. For instance, the date, Dec. 15, 2007, may be specified in an unstructured text as, 12-2008-15. A format interpretation rule may specify how the textual element, 12-2008-15, should be interpreted by the pre-processing logic 10. The format interpretation rule may indicate whether “15” is to be interpreted as a day, month or year. In one embodiment of the invention, user-specified format interpretation rules 14 may specify an order or priority for which different formats are to be used in interpreting a textual element. If, for example, it is more likely that a date will appear in one format over another (e.g., because the source document was generated in a particular geographical location), then that format which is most likely to occur in the unstructured text will be used first in attempting to interpret the date. In many cases, the proper value of a textual element can be inferred from the value and format provided. As an example, the numbers “15” in the date, 12-2008-15, will be interpreted as a day, because it does not make sense if interpreted as a month. However, in certain situations, it may not be possible to properly infer the correct format based on the values given. In these situations, the default interpretation rule will be used.

The next pre-processing directive—the standard format conventions 24—indicates for each textual element type the standard format that is used in generating the pre-processed text 16. Accordingly, a standard format for a textual element type may be specified to match that format expected by the analytical processing tools 20. For instance, if an analytical processing tool 20 expects dates to be written in the form, “YYYYDDMM”, where “YYYY” indicates a four-number year, “DD” indicates a two-number day, and “MM” indicates a two-number month, then the standard format convention for date type textual elements will direct the pre-processing logic 10 to use the specific format for dates. The standard format conventions 24 can be configured by a user for each textual element type. If there is no user-specified standard format convention for a particular textual element type, the pre-processing logic 10 may utilize a default standard format for that textual element type.

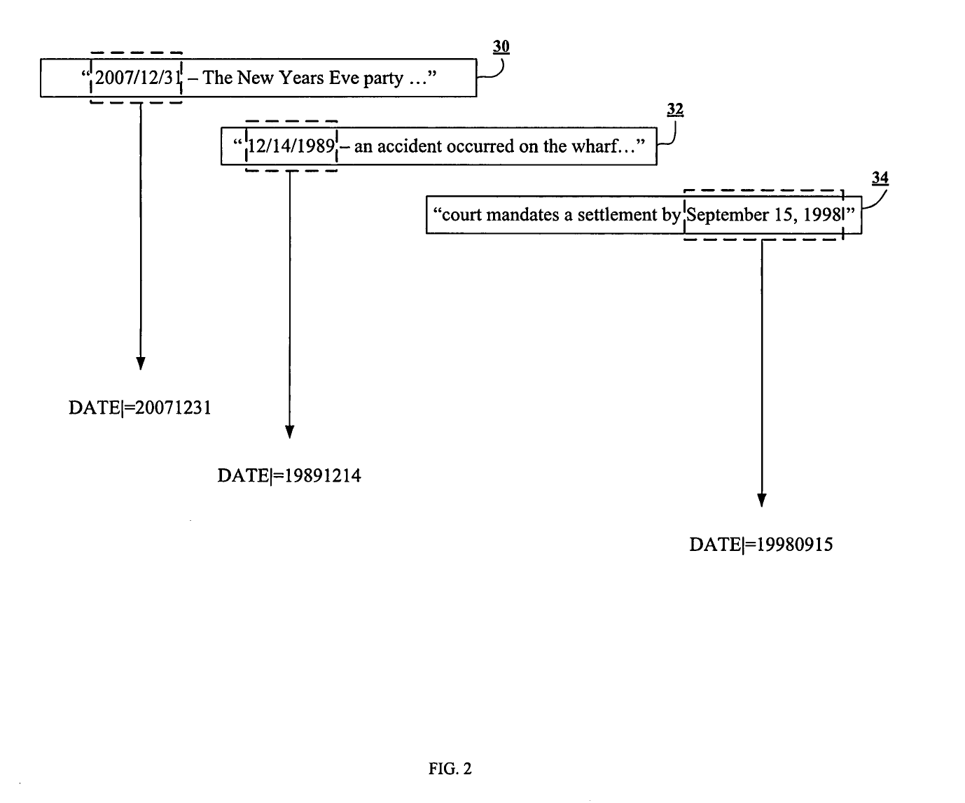

FIG. 2 illustrates three snippets of text 30, 32 and 34 from various sources of unstructured text. Each snippet of text includes a date specified in a different format. For instance, the first snippet includes a date specified as, 2007/12/31. The second includes a date specified as, Dec. 14, 1989, while the third snippet has the date, Sep. 15, 1989. When the pre-processing logic 10 processes these snippets of text, it will use the format interpretation rules 22 to determine the proper date, given the provided values. After mapping each value (e.g., 2007) to the proper unit (e.g., year), the pre-processing logic 10 uses the standard format conventions 24 to format each date in accordance with a specified standard format for dates. In this case, the standard format includes specifying the date in variable format with a variable name “DATE” and a variable value for the date in the form “YYYYMMDD”. The symbol “|=” indicates that the variable “DATE” takes on the corresponding value, for example, “20071231”.

Another set of pre-processing directives shown in FIG. 1 is the taxonomy and word lists 26. As described below in greater detail, the taxonomy and word lists 26 are just that—taxonomies and word lists. The taxonomies and word lists 26 are used by the pre-processing logic 10 to generate alternative representations of certain textual elements found in the unstructured text 12. For example, a user may create a taxonomy that categorizes fruits and vegetables. The pre-processing logic 10 will identify when a word included in the taxonomy occurs in the unstructured text and then generate an alternative representation of that word. For example, every time a fruit name (e.g., apple, banana, or pear) appears in the unstructured text, the word “fruit” may be inserted into the unstructured text as an alternative representation of the specific fruit.

In one embodiment of the invention, the pre-processing logic 10 includes a user interface component (not shown) that allows a user to create, import and/or edit various taxonomies or word lists. Accordingly, existing commercial taxonomies can be imported into an application, edited if necessary, and utilized with the pre-processing logic 10 to process unstructured text. Similarly, the user interface component enables new word lists and taxonomies to be generated, edited and saved for later use.

Another type of pre-processing directive 14 illustrated in FIG. 1 that can be configured by the user is referred to herein as proximity rule 28. A proximity rule 28 specifies when the pre-processing logic 10 should generate an alternative representation of a pair of textual elements that are identified within the unstructured text within a predefined proximity to one another. For example, a user may want to insert an alternative textual element when two textual elements are located close together. Accordingly, the user can generate a proximity rule that instructs the pre-processing logic 10 to generate and insert the alternative representation when two specific textual elements occur within a specified proximity. In various embodiments of the invention, the proximity may be specified in different ways, such as by the number of words between two textual elements, the number of characters, or the number of bytes.

In one embodiment of the invention, the pre-processing logic 10 takes an iterative approach in processing the unstructured text 12. For example, the pre-processing logic 10 may make several “passes” over the unstructured text, performing a different processing task for each pass. For instance, during a first pass, the pre-processing logic 10 may create an index that includes only those textual elements determined to be relevant. This determination may be made in accordance with some built-in logic that recognizes sentence structure, punctuation and other basic grammatical rules. For instance, articles and prepositions may be excluded. Once an index is created with those textual elements deemed relevant, the pre-processing logic 10 may make a second pass performing a processing task consistent with one of the user-specified pre-processing directives. For instance, during the second pass, the pre-processing logic 10 may identify a certain type of textual element (e.g., numbers), and generate and insert into the index alternative representations of those textual elements conforming to user-specified standard formats. In each subsequent pass or processing phase, a different pre-processing directive is performed until the pre-processing logic 10 has completely processed the unstructured text in accordance with all user-specified pre-processing directives 14. The order in which the pre-processing directives are processed may be user-defined. Furthermore, in an alternative embodiment of the invention, the pre-processing logic 10 may perform multiple processing tasks in a single pass.

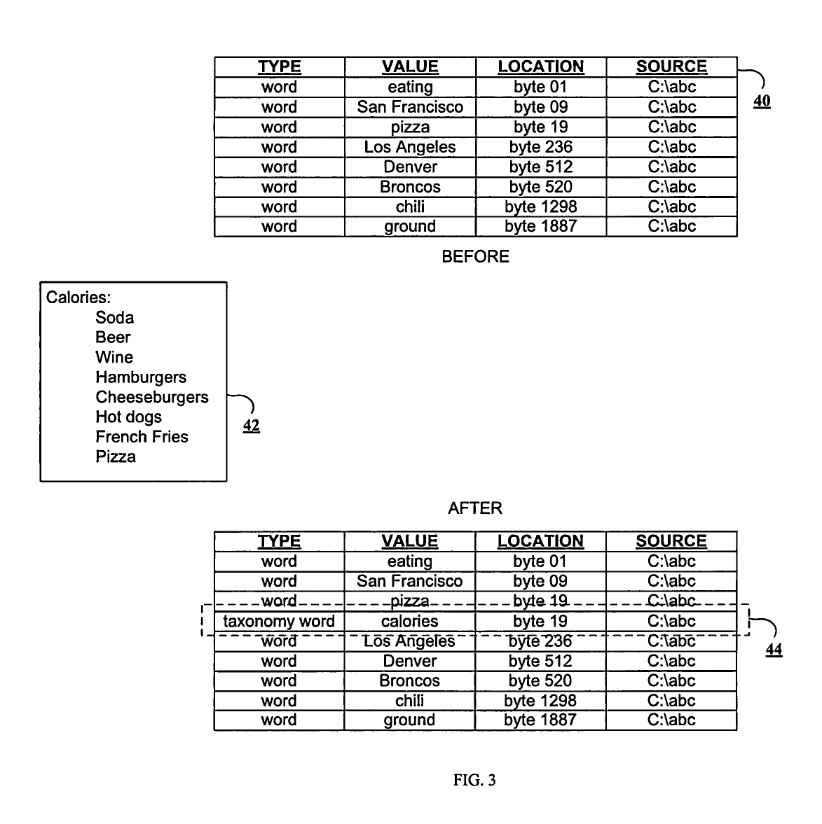

In the examples illustrated in FIGS. 3, 4, and 5, an index is shown in table form both before and after the pre-processing logic 10 has performed a pre-processing operation consistent with a user-specified pre-processing directive. In each example, the table representing the unstructured textual data before the pre-processing directive has been performed shows an initial index created by the pre-processing logic from an unstructured text. That is, the pre-processing logic 10 has created an initial index shown in table form that includes only those textual elements that have been deemed relevant. To illustrate how a particular pre-processing directive may affect the initial index (shown in the table labeled “BEFORE”), the same index (shown in the table labeled “AFTER”) is shown after the pre-processing directive has been processed by the pre-processing logic 10.

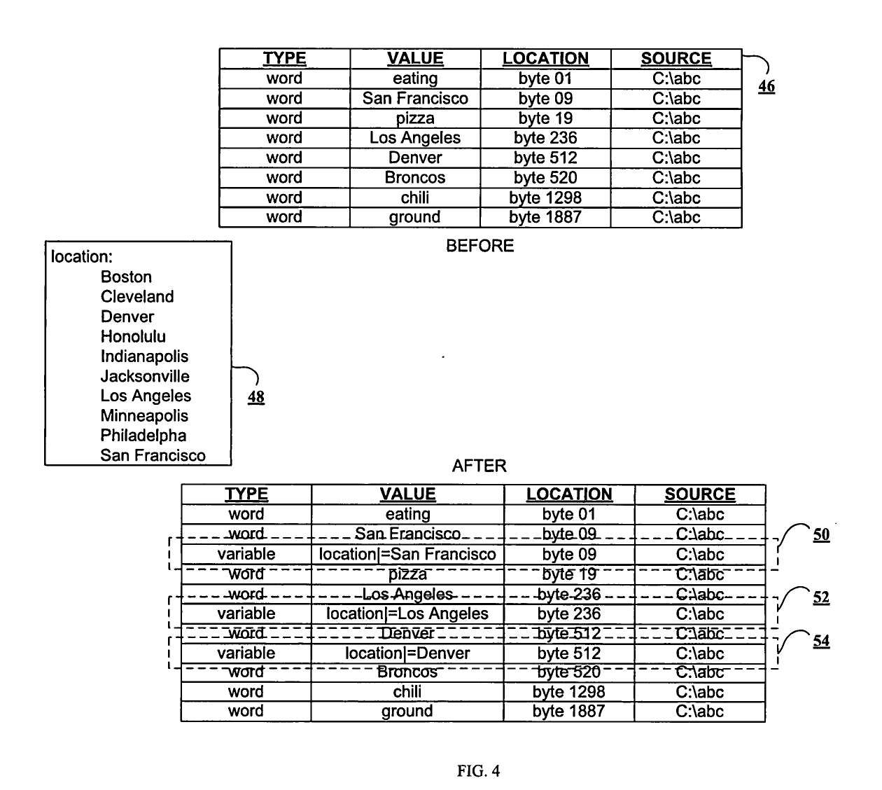

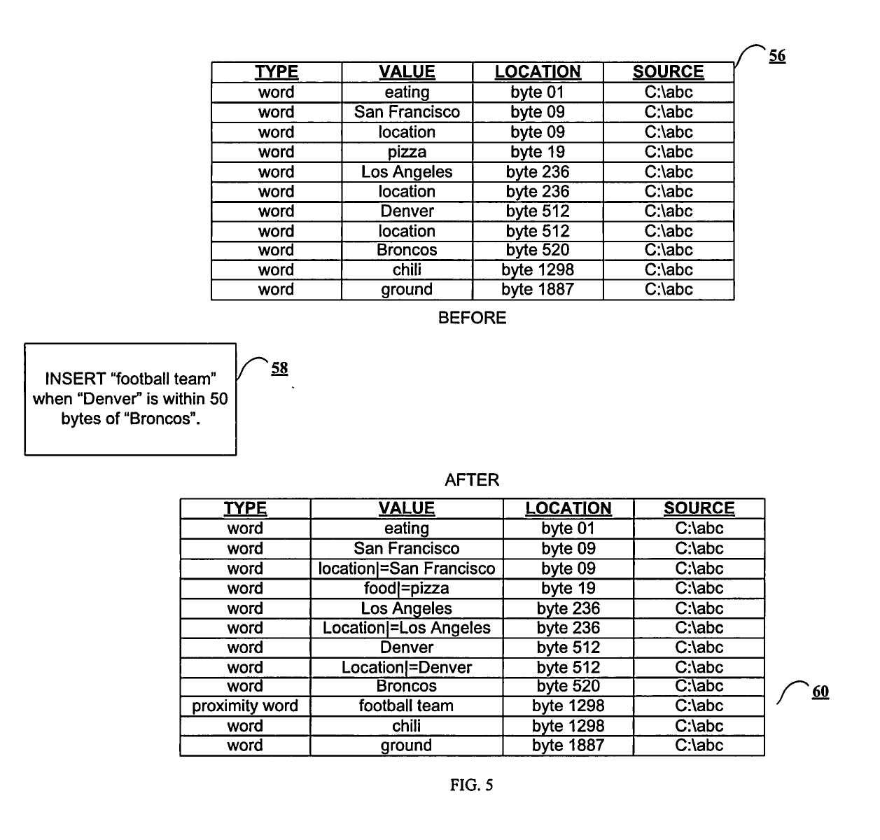

FIGS. 3 and 4 illustrate examples of how a taxonomy or word list may be utilized, according to an embodiment of the invention, to standardize textual elements in an unstructured text. As illustrated in FIG. 3, the table with reference number 40 represents an index of textual elements (in this case, words) that has been generated from an unstructured text. In the table 40, the column with heading “TYPE” indicates the type of textual element, while the column with heading “VALUE” indicates the exact word that has been extracted from the unstructured text. The columns labeled “LOCATION” and “SOURCE” specify the position or location of the word within the text, and the file (or source) from which the word or phrase was extracted, respectively. In one embodiment of the invention, the pre-processing logic 10 analyzes the words in the table 40 to determine if any of the words are included in a taxonomy or listing of words, such as that shown in FIG. 3 with reference number 42. In this example, the word “pizza”, which according to table 40 appears at byte 19 of the file with path and name, “C:\abc”, is also included in the list of words 42 under the heading, “calories”. Accordingly, the pre-processing logic 10 inserts a new row 44 into table 40 adding the word “calories”, which for purposes of the analytical processing tool is viewed as a representation of the word “pizza”. The analytical processing tool can now query the index for the word, “calorie”, and depending upon the particular configuration of the tool, “pizza” and/or “calorie” will be returned in response to the query.

In FIG. 4, the result of a similar pre-processing directive is shown. In particular, FIG. 4 illustrates how the alternative representation of a particular word identified in the original unstructured text may be specified as a variable. For example, as illustrated in FIG. 4, a taxonomy or list of words 48 is used to generate variables associated with particular locations specified as proper nouns. As illustrated in the partially processed unstructured text represented by the index of table 46, the words “San Francisco”, “Los Angeles”, and “Denver” are shown. In a particular application, it may be desirable to have these particular proper nouns represented as or assigned to variables, with a variable name of “location.” This enables a user of an analytical processing tool to easily specify a query utilizing the variable and specific values assigned to the variable. To achieve this, a user may create a pre-processing directive that, when processed by the pre-processing logic 10, identifies certain words in the unstructured text which are also included in a list or taxonomy of words (e.g., taxonomy 48), and assigns those words to a new variable that is inserted into the index. For instance, as illustrated in FIG. 4, the word “San Francisco” has been assigned to a new variable with name “location”, and inserted into the index 50. In this example, the characters “|=” are interpreted as a variable assignment operator. Similarly, as indicated by the rows 52 and 54 of table 46 in FIG. 4, a variable has been generated for the locations corresponding to “Los Angeles” and “Denver” as well.

FIG. 5 illustrates an example of an index 56 including words from an unstructured text before and after pre-processing logic 10 has added an alternative word representing the existence of two specific words within close proximity to one another, according to an embodiment of the invention. In one embodiment of the invention, a user-defined pre-processing directive 58 may specify what is referred to herein as a proximity rule. As used herein, a proximity rule is a rule that performs some processing task when the pre-processing logic 10 identifies two textual elements within close proximity to one another in an unstructured text. The textual elements may be words, phrases, variables, or variable values. Furthermore, the particular measure of proximity may be different in various embodiments of the invention, and will generally be user-definable. Accordingly, when defining a particular proximity rule a user may specify that an action is to be taken when a first textual element is found to be within a certain range or distance (specified in words, bytes or some other measure) of another textual element. Furthermore, the user-defined proximity for a proximity rule may also be specified in terms of its direction. For instance, a proximity rule may be defined such that the pre-condition that must be satisfied in order for the processing task to be performed requires that a first word be located within a particular direction of a second word, for example, after or before the second word.

Turning again to the specific example illustrated in FIG. 5, there is shown a table with an index representing unstructured text before and after the pre-processing logic 10 has processed a proximity rule 58. In this case, the proximity rule 58 has been specified to insert the phrase “football team” when a variable named “location” has assigned to it the value “Denver”, and is located within fifty bytes of the word “Broncos”. As illustrated in the table 56 of FIG. 5, the word Denver appears at byte offset 512 in the file “C:\abc”, and the word “Broncos” appears at byte offset 520. Accordingly, the proximity rule 48 causes the word “football team” to be inserted into the index, as indicated by row 60 in FIG. 5. Although the word “football team” is inserted at the same byte location as the word “Broncos” byte 520 in the example, the particular location of the inserted word or variable may vary depending upon the proximity rule. For instance, the inserted word or variable (e.g., “football team” in the example of FIG. 5) may be inserted at the location of the first word (e.g., “Denver”) in the word pair specified by the proximity rule, or the second word (e.g., “Broncos”), or somewhere in between, before or after. In one embodiment of the invention, the location of the inserted word is determined by the proximity rule, and is user-definable.

It will be appreciated by those skilled in the art that the proximity rule shown in FIG. 5 is in essence pseudo-code that is meant to serve as an example. Depending upon the particular implementation, the proximity rule may be specified in a variety of ways. In one embodiment of the invention, a graphical user interface may include a pre-processing directive editor that enables a user to specify various pre-processing directives, including proximity rules. For instance, such an editor may enable a user to save and reuse certain pre-processing directives with different unstructured texts.

In defining a proximity rule, the textual elements being analyzed may be words included in the original unstructured text, or words and/or variables that have been inserted into the unstructured text as a result of a previously processed pre-processing directive. Accordingly, the order in which the pre-processing directives are processed may play a part in determining the resulting index. If, for instance, a first pre-processing directive results in the addition to the unstructured text of a particular word, this additional word may be specified in a proximity rule, such that the proximity rule causes yet another textual element (word or variable) to be added to the unstructured text when the particular word is identified during the processing of the proximity rule. By way of example, a first pre-processing directive may cause the pre-processing logic to standardize the format of all dates expressed within the unstructured text. A second pre-processing directive may cause the pre-processing logic to insert the word Christmas into the unstructured text whenever the data December 25 is found within the unstructured text and expressed in user-defined the standard format for dates.

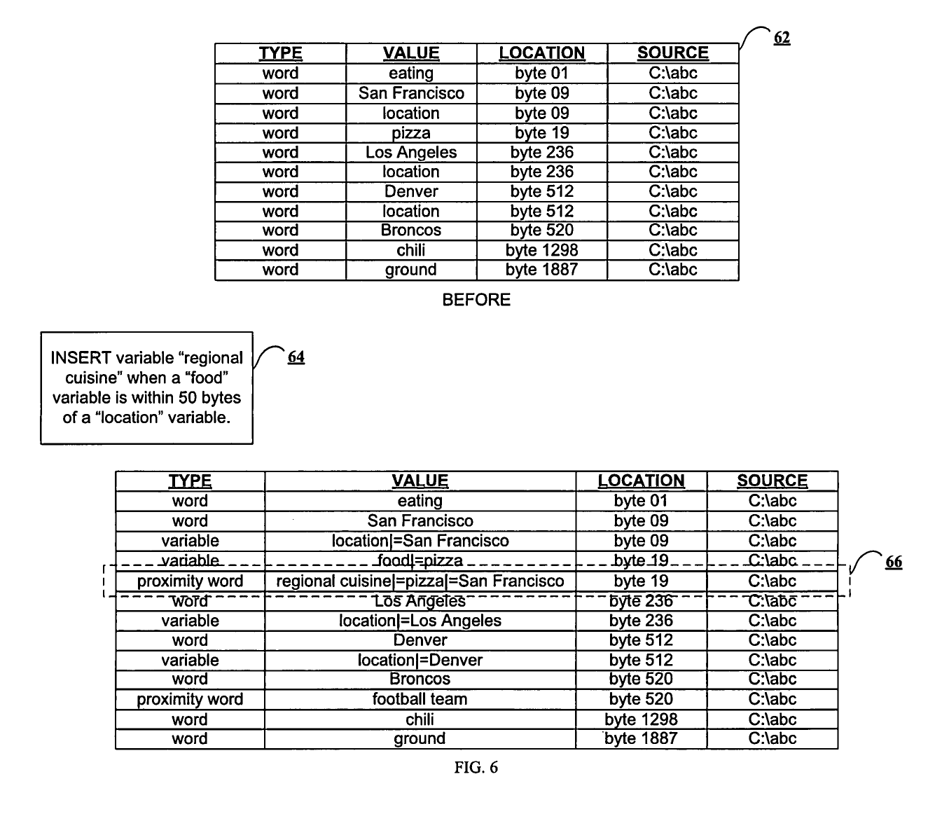

Although the example shown in FIG. 5 illustrates a proximity rule for which an alternative word is inserted into the unstructured text when two textual elements are within proximity to one another, in an alternative embodiment, a proximity rule may be based on the existence of three, four or even more textual elements being located within a user-defined proximity to one another. Furthermore, as described in connection with the example of FIG. 6, a variable name may be assigned a value when two or more words are within a user-defined proximity to one another.

In one final example, FIG. 6 illustrates an index 62 including words from an unstructured text before and after pre-processing logic has added a variable (e.g., the row with reference number 66) to represent the existence of two specific words within close proximity to one another, according to an embodiment of the invention. As illustrated in FIG. 6, the variable with variable name “regional cuisine” has been assigned a value of “pizza” for the location of “San Francisco”. This assignment is the result of processing the proximity rule included in the pre-processing directive 64.

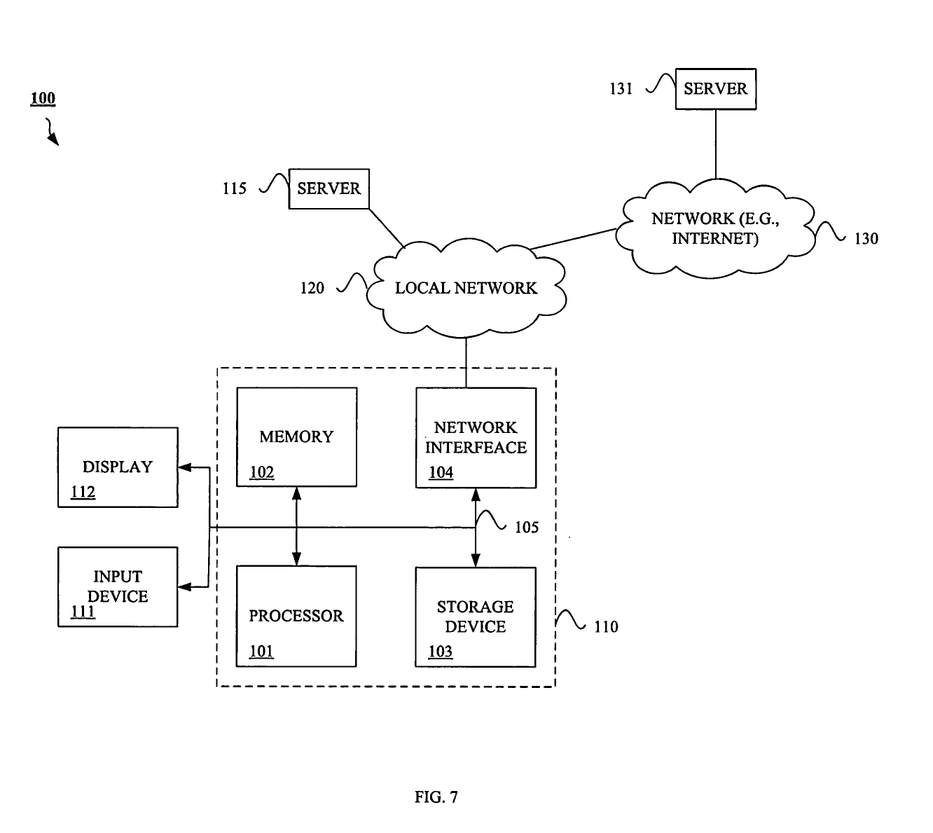

FIG. 7 is a block diagram of an example computer system and network 100 for implementing embodiments of the present invention. Computer system 110 includes a bus 105 or other communication mechanism for communicating information, and a processor 101 coupled with bus 105 for processing information. Computer system 110 also includes a memory 102 coupled to bus 105 for storing information and instructions to be executed by processor 101, including information and instructions for performing the techniques described above. This memory may also be used for storing temporary variables or other intermediate information during execution of instructions to be executed by processor 101. Possible implementations of this memory may be, but are not limited to, random access memory (RAM), read only memory (ROM), or both. A non-volatile mass storage device 103 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 103 may include source code, binary code, or software files for performing the techniques or embodying the constructs above, for example.

Computer system 110 may be coupled via bus 105 to a display 112, such as a cathode ray tube (CRT), liquid crystal display (LCD), light emitting diode (LED), electrophoretic (e-ink), or organic light emitting diode (OLED), etc. for displaying information to a computer user. An input device 111 such as a keyboard and/or mouse is coupled to bus 105 for communicating information and command selections from the user to processor 101. The combination of these components allows the user to communicate with the system. In some systems, bus 105 may be divided into multiple specialized buses. Those of skill in the art would appreciate that computer system 110, display 112 and input device may be configured as a smart phone, a tablet, or any other smart device that could communicate with the system through the network.

Computer system 110 also includes a network interface 104 coupled with bus 105. Network interface 104 may provide two-way data communication between computer system 110 and the local network 120. The network interface 104 may be a digital subscriber line (DSL), T-1, E-1, wireless, or any other type of network interface capable of connection to a network, e.g. a modem to provide data communication connection over a telephone line. Another example of the network interface is a local area network (LAN) card to provide a data communication connection to a compatible LAN. In any such implementation, network interface 104 sends and receives electrical, electromagnetic, or optical signals that carry digital data streams representing various types of information.

Computer system 110 can send and receive information, including messages or other interface actions, through the network interface 104 to an Intranet or the Internet 130. In the Internet example, software components or services may reside on multiple different computer systems 110 or servers 115 and 131 across the network. A server 131 may transmit actions or messages from one component, through Internet 130, local network 120, and network interface 104 to a component on computer system 110.

As indicated by the examples illustrated and described herein, an embodiment of the invention provides great flexibility in defining pre-processing directives and manipulating an unstructured text in order to condition the text for analysis by one or more analytical processing tools. The above description illustrates various embodiments of the present invention along with examples of how aspects of the present invention may be implemented. The above examples and embodiments should not be deemed to be the only embodiments, and are presented to illustrate aspects and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

While the invention herein disclosed has been described by means of specific embodiments and applications thereof, numerous modifications and variations could be made thereto by those skilled in the art without departing from the scope of the invention set forth in the claims.

What is claimed is:

1. A computer-based method for identifying potential legal liability comprising:
obtaining factual information associated with a database selected from a group consisting of previous legal liability to an enterprise, threatened legal liability to an enterprise, factual predicates for various theories of legal liability, and combinations thereof;
obtaining words of worry for adverse consequences;
generating seeding information based on said factual information in combination with said words of worry;
providing said seeding information to a detection engine, wherein said detection engine generates an output comprising words that may trigger legal liability;
generating analysis parameters comprising said words that may trigger legal liability;
generating a database of business relevant emails;
feeding said database of business relevant emails and said analysis parameters to said detection engine to scan for facts that may constitute liability risks;
identifying and storing emails with said facts that may constitute liability risks into an output database; and
providing said emails in said output database to authorized personnel for review.

2. The method of claim 1, wherein said analysis parameters further comprises additional words provided by a user.

3. The method of claim 2, wherein said analysis parameters further comprises Frequency Words and Proximity Words, wherein said words that may trigger legal liability and said additional words provided by said user are collectively Words of Concern and said Frequency Words and said Proximity Words are generated from said Words of Concern.

4. The method of claim 1, wherein said factual information comprises factual allegations from litigation records associated with other enterprises having same or similar SIC code.

5. The method of claim 1, wherein said database of business relevant emails is generated by a filter running on said detection engine with inputs to said filter comprising email archives of said enterprise and filter parameters comprising relevance taxonomies for said enterprise.

6. The method of claim 1, wherein said factual information comprises a compilation of factual allegations previously presented as part of a filed lawsuit.

7. The method of claim 1, wherein said factual information comprises factual details extracted from hypothetical examples of potential legal liability, including as identified and input by authorized personnel.

8. The method of claim 1, wherein said factual information comprises factual details extracted from learned treatises, including as identified by authorized personnel.

9. The method of claim 1, wherein said authorized personnel are attorneys or non-attorneys acting under the direction or control of attorneys.

10. The method of claim 1, wherein said factual information comprises factual details from employee complaints.

11. The method of claim 1, wherein said factual information comprises factual details from customer complaints.

12. The method of claim 1, wherein said factual information comprises factual details from lawsuits previously initiated against said enterprise.

13. A computer-based method for identifying potential legal liability comprising:
obtaining factual information associated with the factual predicates for various theories of legal liability;
obtaining words of worry for adverse consequences;
generating seeding information based on said factual information and said words of worry;
providing said seeding information to a detection engine, wherein said detection engine generates an output comprising words that may trigger legal liability;
generating analysis parameters comprising said words that may trigger legal liability;
obtaining archives of emails from said enterprise;
generating a database of business relevant emails by applying a filter with specified filter parameters to said archives of emails, wherein said specified filter parameters comprise relevance taxonomy for said enterprise;
feeding said database of business relevant emails and said analysis parameters to said detection engine to scan for facts that may constitute liability risks;
identifying and storing emails with said facts that may constitute liability risks into an output database; and
providing said emails in said output database to authorized personnel for review.

14. The method of claim 13, wherein said analysis parameters further comprises additional words provided by a user.

15. The method of claim 13, wherein said factual information is selected from the group consisting of factual allegations from litigation records associated with other enterprises having same or similar SIC code, factual details extracted from hypothetical examples of potential legal liability as identified and input by authorized personnel, factual details extracted from learned treatises as identified by authorized personnel, factual details from employee complaints, factual details from customer complaints, factual details from lawsuits previously initiated against said enterprise, and combinations thereof.

16. The method of claim 13, wherein said archives of emails further comprises real-time feed of email communication within said enterprise.

17. The method of claim 14, wherein said analysis parameters further comprises Frequency Words and Proximity Words, wherein said words that may trigger legal liability and said additional words provided by said user are collectively Words of Concern and said Frequency Words and said Proximity Words are generated from said Words of Concern.

18. A computer-based method for identifying potential legal liability comprising:
obtaining factual information associated with previous legal liability to an enterprise, threatened legal liability to an enterprise, and factual predicates for various theories of legal liability;
obtaining words of worry for adverse consequences;
generating seeding information based on said factual information in combination with said words of worry;
providing said seeding information to a detection engine, wherein said detection engine generates an output comprising words that may trigger legal liability;
generating analysis parameters comprising said words that may trigger legal liability;
generating a database of business relevant emails;
feeding said database of business relevant emails and said analysis parameters to said detection engine to scan for facts that may constitute liability risks;
identifying and storing emails with said facts that may constitute liability risks into an output database; and
providing said emails in said output database to authorized personnel for review.
